(19) United States
(12) Patent Application Publication
(10) Pub. No.: US 2023/0288381 A1
(43) Pub. Date: Sep. 14, 2023

(54) SAMPLE ANALYZING DEVICE

(71) Applicant: SHIMADZU CORPORATION, Kyoto-shi (JP)

(72) Inventors: Yoshito KAWAKITA, Kyoto-shi (JP); Noriyuki OJIMA, Kyoto-shi (JP)

(73) Assignee: SHIMADZU CORPORATION, Kyoto-shi (JP)

(21) Appl. No.: 18/159,812

(22) Filed: Jan. 26, 2023

(30) Foreign Application Priority Data
Mar. 14, 2022 (JP) 2022-038973

(51) Int. Cl. G01N 30/06

(52) U.S. Cl. CPC G01N 30/06; G01N 2030/025

(57) ABSTRACT

In a sample analyzing device (1), a storage section (21) holds information concerning measurement conditions and data-analysis methods for a plurality of known compounds as well as information concerning a plurality of filters each of which extracts a subset of the known compounds. A measurement controller (224) obtains measurement data of a sample by performing a measurement based on the measurement conditions held in the storage section. A filter selection receiver (221) receives an input for selecting one of the filters as a data-analysis filter. A data-analysis-target-compound extractor (223) extracts, as data-analysis target compounds, a subset of the known compounds by the data-analysis filter. A display controller (226) displays, on a display section (26), a first data-analysis screen for displaying measurement data of the data-analysis target compounds and a second data-analysis screen for displaying all measurement data.

### TECHNICAL FIELD

The present invention relates to a sample analyzing device for analyzing compounds contained in a sample.

### BACKGROUND ART

Metabolomics is a technique for comprehensively analyzing the kinds and concentrations of various metabolites resulting from vital actions. This technique has been expected to be applied in various areas. For example, in the area of medical care, the technique is expected to be applied in the search for biomarkers for the purpose of the early detection of specific diseases or the identification of the causal substances of specific diseases. In the area of food production, the technique can be applied in the evaluation or prediction of product qualities, such as the comparison of products of different manufacturers or the comparison of raw materials from different places of origin, as well as the search for functional ingredients.

One of the techniques for analyzing metabolites in metabolomics is gas chromatography-mass spectrometry. In an analysis of metabolites by gas chromatography-mass spectrometry, a database is used in which information concerning measurement conditions and data-analysis methods is recorded for each of the large number of known metabolites (for example, see Non Patent Literature 1). For example, the information concerning the measurement conditions includes the retention time of each metabolite and the mass-to-charge ratio of an ion which characterizes each metabolite. The information concerning the data-analysis methods includes, for example, analytical parameters used for creating a mass chromatogram or total ion current chromatogram from measurement data, or for extracting a peak from a chromatogram, as well as information related to a calibration curve used for determining the quantity of a metabolite from the area of the peak. By using those pieces of information concerning the measurement conditions and data-analysis methods recorded in the database, the person in charge of the analysis can perform a comprehensive analysis of various metabolites contained in a sample, without weighing measurement conditions and data-analysis methods by themselves.

### CITATION LIST

### Non Patent Literature

Non Patent Literature 1: “Smart Metabolites Database”, [online], Shimadzu
Corporation [accessed on Feb. 14, 2022], the Internet

### SUMMARY OF INVENTION

### Technical Problem

Metabolomics has a wide variety of targets. A database used in a metabolome analysis for a comprehensive analysis of metabolites holds information related to a large number of metabolites which may possibly be contained in one of the samples of various attributes. The number of metabolites registered in the database has been increasing with the expanding range of targets of metabolomics. Therefore, while a comprehensive measurement of a large number of metabolites can be performed based on the measurement conditions registered in the aforementioned type of database, a considerable amount of time and labor is required when a huge amount of measurement data is to be analyzed.

The problem to be solved by the present invention is to provide a technique by which compounds contained in a sample can be easily analyzed using a database even when the database holds a huge amount of information concerning the measurement conditions and data-analysis methods for known compounds.

Solution to Problem

A sample analyzing device according to the present invention developed for solving the previously described problem includes:
a storage section which holds information concerning measurement conditions and information concerning data-analysis methods for each of a plurality of known compounds as well as information concerning a plurality of data filters each of which extracts a subset of the plurality of known compounds;
a display section;
a measurement controller configured to obtain measurement data of a sample containing one or a plurality of the plurality of known compounds by performing a measurement based on the information concerning one or a plurality of measurement conditions held in the storage section;
a filter selection receiver configured to receive an input for selecting one of the plurality of data filters as a data-analysis filter to be applied to an analysis of the measurement data of the sample;
an analysis-target-compound extractor configured to extract, as data-analysis target compounds, a subset of the plurality of known compounds by the data-analysis filter; and
a display controller configured to display, on the display section, a first data-analysis screen for displaying measurement data of the data-analysis target compounds extracted from the measurement data of the sample and a second data-analysis screen for displaying all measurement data.

### Advantageous Effects of Invention

The sample analyzing device according to the present invention includes a storage section which holds not only information concerning the measurement condition and data-analysis method for each of a plurality of known compounds, but also information concerning a plurality of data filters for extracting a subset of the plurality of known compounds. When an analysis of a sample containing one or a plurality of the plurality of known compounds is performed, a measurement based on the information concerning the measurement conditions for the plurality of known compounds held in the storage section is performed to obtain measurement data of that sample. The filter selection receiver receives a selection of a data-analysis filter by a user, for example. The analysis-target-compound extractor extracts one or more known compounds corresponding to that data filter (data-analysis target compounds). The display controller displays a first data-analysis screen for displaying measurement data of the data-analysis target compounds and a second data-analysis screen for displaying all measurement data. The display controller may be configured to display the first and second data-analysis screens in a switchable manner, or to simultaneously display the first and second data-analysis screens next to each other. The display of the first and second data-analysis screens is performed based on an instruction from the user, for example. In the sample analyzing device according to the present invention, for example, the user only needs to perform a simple operation for selecting a filter for data analysis according to the content of the analysis of the sample to narrow down the compounds to be analyzed. In response to this operation, the first data-analysis screen which shows measurement data of those data-analysis target compounds is displayed, allowing the user to easily analyze those compounds. Measurement data of the compounds other than the data-analysis target compounds can also be checked on the second data-analysis screen as needed.

### BRIEF DESCRIPTION OF DRAWINGS

FIG. 1 is a configuration diagram of the main components of a gas chromatograph mass spectrometer as one embodiment of the sample analyzing device according to the present invention.

FIG. 2 is one example of a compound database in the present embodiment.

FIG. 3 is one example of filter information in the present embodiment.

FIG. 4 is one example of the second data-analysis screen in the present embodiment.

FIG. 5 is one example of the first data-analysis screen in the present embodiment.

FIG. 6 is one example of the screen for adding a non-target compound to a list of the data-analysis target compounds.

FIG. 7 is one example of the filter creation screen in the present embodiment.

FIG. 8 is one example of the filter editing screen in the present embodiment.

### DESCRIPTION OF EMBODIMENTS

An embodiment of the sample analyzing device according to the present invention is hereinafter described with reference to the drawings. The sample analyzing device according to the present embodiment is used, for example, for an analysis of various metabolites contained in samples of various attributes, such as samples from a plant, animal or other origins, as well as biological samples. This type of technique used for comprehensively analyzing the kinds and concentrations of various metabolites contained in a sample is called “metabolomics”. This technique is used for analyzing specific metabolites contained in a biological sample to detect specific diseases in their early phase, or for analyzing specific metabolites contained in a food-product sample to evaluate the quality of the product or identify its place of origin. The metabolites to be detected by a measurement in metabolomics are known compounds. In many cases, one or more data-analysis target compounds are previously specified according to an attribute of the sample (e.g., the kind of sample).

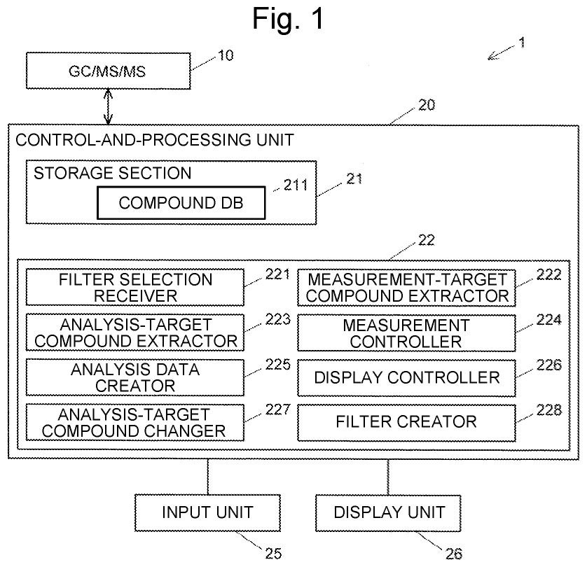

FIG. 1 is a configuration diagram of the main components of a gas chromatograph mass spectrometer 1 as one embodiment of the sample analyzing device according to the present invention. The gas chromatograph mass spectrometer 1 according to the present embodiment roughly consists of a gas chromatograph mass spectrometry unit (GC/MS/MS) 10, which is a measurement unit, and a control-and-processing unit 20.

The GC/MS/MS 10 is a combination of a gas chromatograph for separating various compounds contained in a sample and a mass spectrometry unit for sequentially analyzing the compounds separated by the gas chromatograph. The mass spectrometry unit used in the present embodiment is a device capable of an MS/MS analysis (e.g., a triple quadrupole mass spectrometer or ion trap time-of-flight mass spectrometer). This type of device is used in the present embodiment in order to perform an MRM measurement or MS/MS scan measurement. In the case of a system which merely performs a SIM measurement or MS scan measurement, a single quadrupole mass spectrometer or similar type of device may be used.

The control-and-processing unit 20 includes a storage section 21 as well as a filter selection receiver 211, measurement-target-compound extractor 222, analysis-target-compound extractor 223, measurement controller 224, analysis data creator 225, display controller 226, analysis-target-compound changer 227 and filter creator 228 as its functional blocks. The control-and-processing unit 20 is actually a personal computer, with the aforementioned functional blocks embodied by executing pre-installed software (program) on a processor. An input unit 25 and a display unit 26 are connected to the control-and-processing unit 20.

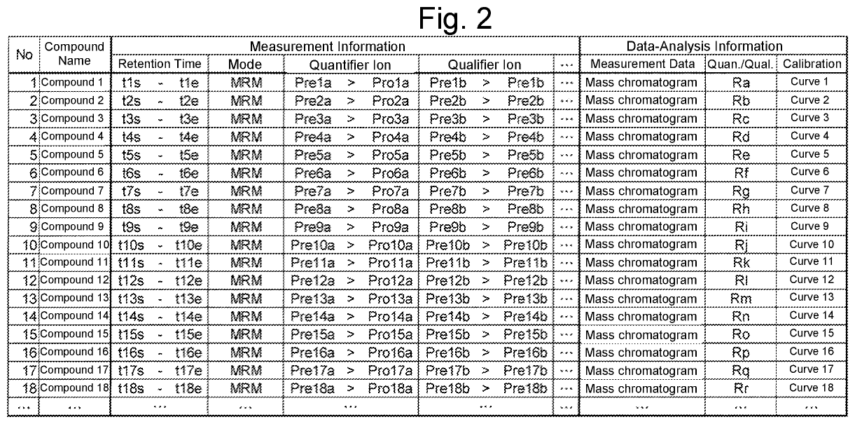

The storage section 21 holds a compound database (compound DB) 211. FIG. 2 shows one example of the compound database 211. The compound database 211 holds measurement information and data-analysis information recorded for each of the large number of known kinds of metabolites (e.g., 500-1000 kinds) that can be detected from various samples. The measurement information includes the type and temperature of a column to be used in the gas chromatograph in a measurement for the metabolite concerned, the kind and flow rate of the carrier gas, the retention time, as well as information concerning the measurement mode (e.g., SIM, MS scan, MRM or MS/MS scan) and the mass-to-charge ratios of ions (the mass-to-charge ratio in the SIM measurement, the range of mass-to-charge ratios in the MS scan measurement, the combination of the mass-to-charge ratios of the MRM transition in the MRM measurement, as well as the mass-to-charge ratio of the precursor ion and the range of mass-to-charge ratios of the product ions in the MS/MS measurement) in the mass spectrometry unit. The data-analysis information includes identification conditions (e.g., the allowable range of the ratio between the measured intensity of the target ion (quantifier ion) and that of the qualifier ion in the SIM measurement, the allowable range of the ratio between the measured intensity of the MRM transition for quantification and that of the MRM transition for qualification in the MRM measurement, or the threshold of the degree of matching between an MS or MS/MS spectrum and a standard spectrum in an MS scan or MS/MS scan measurement), the calibration-curve data (e.g., the relationship between the peak intensity in the chromatogram and the quantitative value), and the standard mass spectrum (e.g., an MS spectrum or MS/MS spectrum).

The compound database 211 also holds filter information. The filter information is used for extracting, from a large number of compounds recorded in the compound database 211, one or more compounds according to an attribute of the sample, as the measurement target compounds and/or data-analysis target compounds related to the sample having that attribute. The sample attributes are hierarchically structured, including the large classification (Attribute A, Attribute B, Attribute C and others), middle classification (Attribute A-1, Attribute A-2, Attribute A-3 and others) and small classification (Attribute A-1-1 and others).

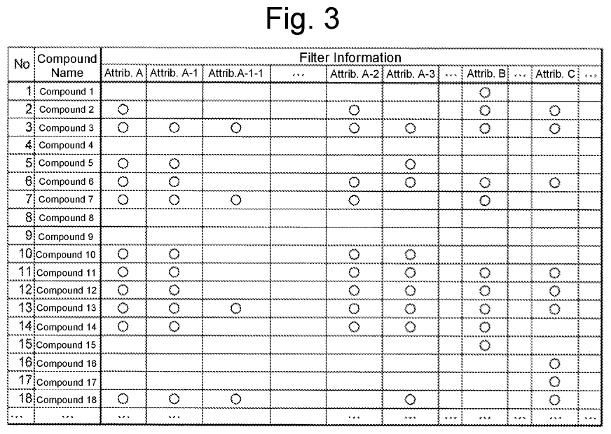

FIG. 3 shows one example of the filter information. The sample attributes in this example are represented by three hierarchical levels, although the number of hierarchical levels may be appropriately changed. It is also possible to eliminate the hierarchical structure and only use the level corresponding to the large classification (Attribute A, Attribute B, Attribute C and others). Examples of the large classification include “plant”, “animal” and the likes. Examples of the middle classification under “plant” include “wheat”, “barley”, “rice”, “soybean” and the likes. Examples of the small classification under “wheat” include “wheat grown in Hokkaido”, “wheat grown in the USA” and the likes. The filters in this hierarchical structure are designed so that a filter at a lower level extracts a smaller number of compounds (metabolites). For example, the filter for the middle classification “wheat” is designed to extract a subset of the compounds (metabolites) extracted by the filter for the large classification “plant”.

An operation of the gas chromatograph mass spectrometer 1 according to the present embodiment is hereinafter described.

A user issues a command to perform an analysis. Then, the filter selection receiver 221 displays, on the display unit 26, a screen which allows the user to select the use or non-use of a measurement filter. When the use of a measurement filter has been selected on this screen, the operation proceeds to a measurement filter selection screen. The sequence of operations in the case of using a measurement filter will be described later.

Next, the measurement controller 224 reads the measurement information of each compound from the compound database 211. In the present example, since no measurement filter is used, the measurement information of each of all compounds recorded in the compound database 211 is read, and a batch file for performing measurements for those compounds is created. It should be noted that it may be impossible to perform the measurements of all compounds in a single sequence if there are a considerable number of compounds to be subjected to the measurements. For example, when a considerable number of compounds having the same retention time are included, the measurements for those compounds must be sequentially performed within the same segment of time, which means that the interval of time for the measurements of those compounds will be considerably long. This may cause the number of measurement points forming a peak in a mass chromatogram to be insufficient, which may lead to a low level of reproducibility of the peak. On the other hand, when the interval of time of the measurement of each compound is set to be shorter so as to provide a sufficient number of measurement points forming a peak in a mass chromatogram, the period of time allotted to each compound per one measurement may possibly be so short that the sensitivity of the measurement may deteriorate. Therefore, referring to a specific condition (e.g., the number of compounds to be subjected to the measurement within the same segment of time should not exceed a predetermined upper limit), the measurement controller 224 creates a plurality of method files as needed and creates a batch file so as to obtain measurement data of all compounds by performing a plurality of sequences of measurements.

After the batch file has been created, the user issues a command to initiate the measurement. Then, the measurement controller 224 sequentially conducts the measurements for the compounds contained in the sample (in the present case, all compounds recorded in the compound database 211). The data obtained by the measurements are sequentially saved in the storage section 21.

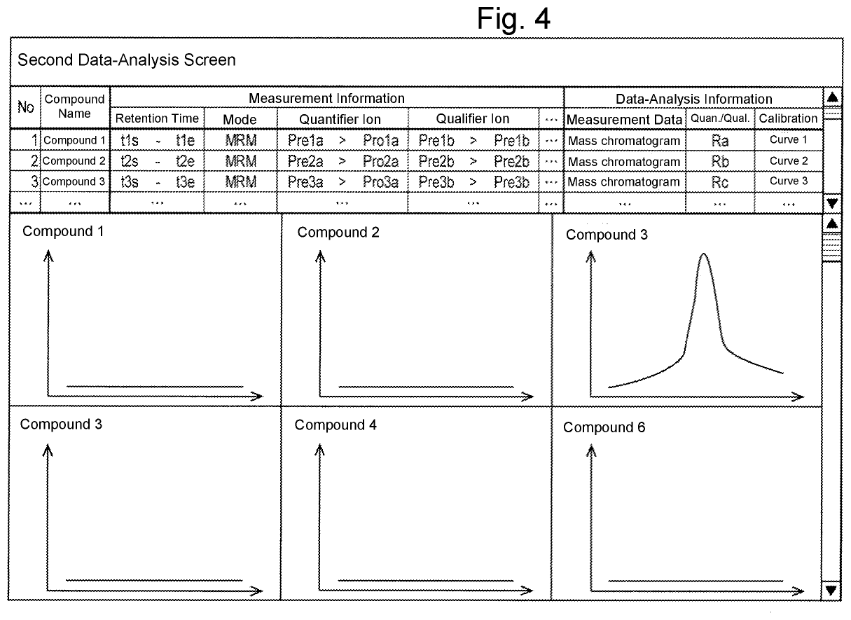

After the completion of the measurements, the display controller 226 initially displays, on the display unit 26, the measurement data of all compounds for which the measurements were performed. The screen thus displayed corresponds to the second data-analysis screen in the present invention. FIG. 4 shows one example of the second data-analysis screen. In this screen example, a list of compounds for which the measurements were performed is displayed (in the present case, all compounds recorded in the compound database 211 are shown since no measurement filter is used), with the measurement data of each compound shown below. For example, a mass chromatogram is displayed as the measurement data for a compound for which an MRM measurement or SIM measurement was performed. A total ion current chromatogram is displayed as the measurement data for a compound for which an MS scan measurement or MS/MS scan measurement was performed. For each compound shown in this screen, the user can determine whether or not the compound concerned is contained in the sample, by checking whether or not a peak is present in the mass chromatogram or total ion current chromatogram (or the like) shown on this screen as the measurement data of the compound concerned. The screen example in FIG. 4 demonstrates that Compound 3 is contained in the sample, while Compounds 1, 2, 5 and 6 are not.

After the second data-analysis screen has been displayed on the display unit 26 by the display controller 226, the filter selection receiver 221 displays, on the display unit 26, a screen for prompting the user to select the use or non-use of a data-analysis filter. When the user has selected the use of a data-analysis filter, the filter selection receiver 221 displays, on the display unit 26, a screen which allows the user to select the data-analysis filter to be used. The user selects one of the data-analysis filters, and the filter selection receiver 221 determines that the selected filter should be used as the data-analysis filter.

After the data-analysis filter has been determined, the analysis-target-compound extractor 223 extracts, from the large number of compounds recorded in the compound database 211, one or more compounds as the data-analysis target compounds according to the content of the selected data-analysis filter. For example, when Attribute A-1-1 is selected, Compounds 3, 7, 13, 18 and others are extracted as the data-analysis target compounds. When no data-analysis filter is used, the measurement data of all compounds recorded in the compound database 211 are analyzed based on the data-analysis information of each compound. When neither the measurement filter nor the data-analysis filter is used, the entire processing will be similar to a conventional data analysis. Therefore, descriptions of this case will be omitted.

After the data-analysis target compounds have been extracted by the analysis-target-compound extractor 223, the analysis data creator 225 analyzes the measurement data of the data-analysis target compounds among the measurement data obtained by the measurements, using the data-analysis information of those compounds. For example, for a compound for which an MRM measurement was performed, a peak is extracted from each of the mass chromatograms obtained from the measurement data of the MRM transition for quantification and the MRM transition for qualification, and the ratio between the area of the mass peak of the MRM transition for quantification and that of the mass peak of the MRM transition for qualification is calculated. Then, whether or not the ratio is within an allowable range specified as an identification condition is determined. The quantitative value is also calculated by comparing the peak area in the mass chromatogram of the MRM transition for quantification with calibration-curve information. As another example, for a compound for which an MS/MS scan measurement was performed, a peak is extracted from the total ion current chromatogram, and an MS/MS spectrum obtained at the peak-top time of the peak is compared with the standard spectrum to determine whether or not the degree of matching of the two spectra exceeds a predetermined threshold. Additionally, the quantitative value is calculated by comparing the peak area of the peak in the total ion current chromatogram with calibration-curve information.

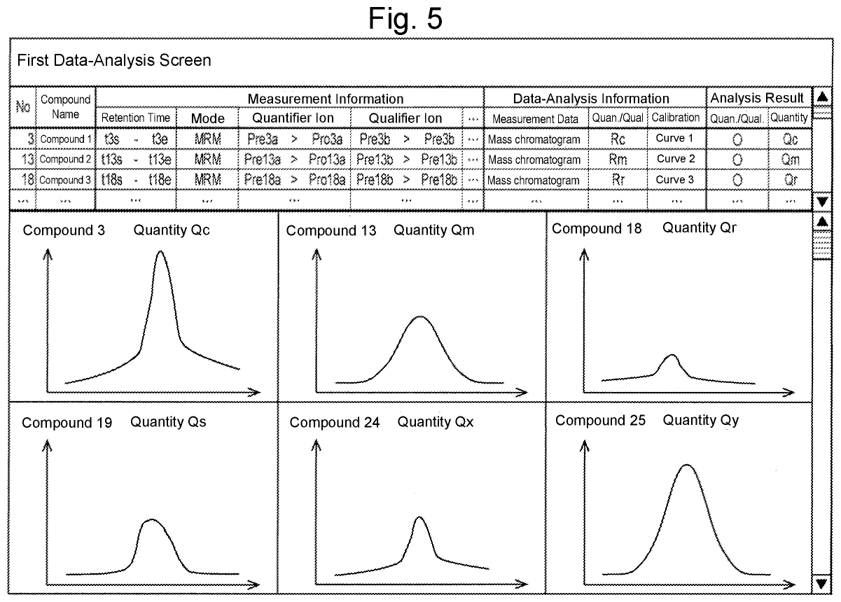

After the analysis data for the data-analysis target compounds have been created, the display controller 226 displays the measurement data and the analysis data of the data-analysis target compounds on the display unit 26. This display screen corresponds to the first data-analysis screen in the present invention. FIG. 5 shows one example of the first data-analysis screen. In this screen example, the compounds extracted by the data-analysis filter (data-analysis target compounds) are listed in the upper section of the screen, with the measurement data (in the example of FIG. 5, the mass chromatogram) and the data-analysis result (the quantitative value) of each data-analysis target compound shown below. By viewing the contents displayed on this screen, the user can easily check data-analysis results of the desired measurement target compounds.

Thus, in the present embodiment, the display controller 226 displays the first data-analysis screen for showing the measurement data and the data-analysis results of the data-analysis target compounds as well as the second data-analysis screen for showing the measurement data of all compounds for which the measurements were performed, based on an instruction from the user. In the present embodiment, the display controller 226 initially displays the second data-analysis screen, and then switches the display to the first data-analysis screen when a data-analysis filter has been selected by the user. The form of the display of the first and second data-analysis screens can be appropriately changed. For example, the display controller 226 may automatically switch the display between the first and second data-analysis screens at specific intervals of time. Simultaneously displaying the first and second data-analysis screens next to each other is also possible.

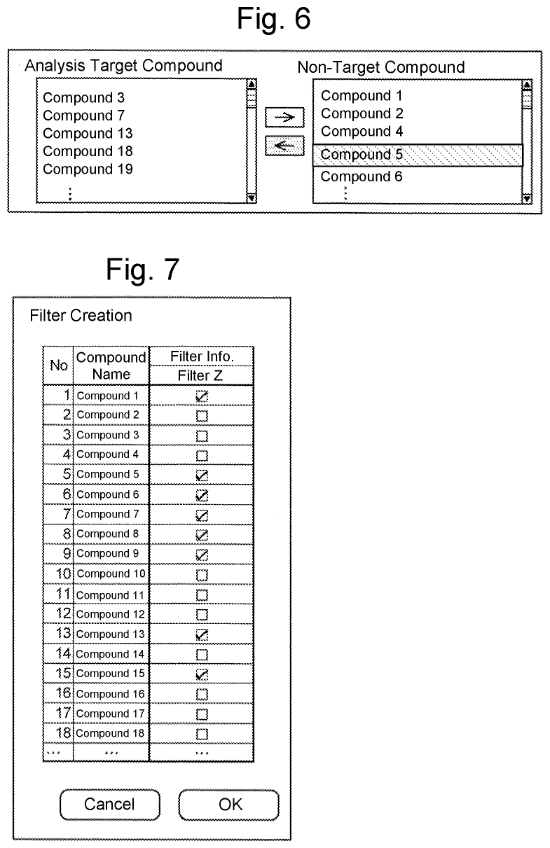

On the second data-analysis screen, for example, when it has been discovered that a piece of significant measurement data has been obtained for a compound whose presence in the sample was not expected before the measurement, that compound can be individually added to the list of the data-analysis target compounds. When a command to change the data-analysis target compounds has been issued by the user, the analysis-target-compound changer 227 shows a list of the data-analysis target compounds and that of the other compounds (non-target compounds) included in the compounds recorded in the compound database 211. In these lists, the user can add a data-analysis target compound, for example, by selecting one of the non-target compounds and performing a predetermined operation for adding it to the list of the data-analysis target compounds. FIG. 6 is an example in which Compound 5, which is a non-target compound, is going to be added to the list of the data-analysis target compounds. The user can also change a data-analysis target compound to a non-target compound. A newly added data-analysis target compound is displayed on the first data-analysis screen from that point in time. A compound removed from the list of the data-analysis target compounds is hidden from the first data-analysis screen from that point in time.

In this example, a subset of the compounds recorded in the compound database 211 is extracted as the data-analysis target compounds by using a data-analysis filter, and only the measurement data and the analysis data of those data-analysis target compounds are displayed on the first data-analysis screen. Therefore, the user can easily perform an analysis of the desired compounds. Additionally, the second data-analysis screen allows the user to check the measurement data of a compound whose presence in the sample was not expected before the measurement. The analysis-target-compound changer 227 allows the unexpected compound to be individually added to the list of the data-analysis target compounds.

Next, an example in which the user has selected the use of a measurement filter is described. When the user has selected the use of a measurement filter, the filter selection receiver 221 displays, on the display unit 26, a screen which allows the user to select the measurement filter to be used. When the user has selected one of the measurement filters and confirmed the selection, the filter selection receiver 221 determines that the selected filter should be used as the measurement filter.

After the measurement filter has been determined, the measurement-target-compound extractor 222 extracts, from the large number of compounds recorded in the compound database 211, one or more compounds as the measurement target compounds according to the content of the measurement filter. For example, when the measurement filter is Attribute A, Compounds 2, 3, 5-7, 10-14, 18 and others are extracted as the measurement target compounds.

Next, the measurement controller 224 reads a method file in which the measurement conditions for the sample are described, and creates a batch file. In the present example, since the measurement filter is used, a plurality of method files prepared for the measurements of the measurement target compounds (Compounds 2, 3, 5-7, 10-14, 18 and others) are read, and a batch file for executing those files is created.

After the batch file has been created, the user issues a command to initiate the measurement. Then, the measurement controller 224 sequentially conducts the measurements for the measurement target compounds contained in the sample. The data obtained by the measurements are sequentially saved in the storage section 21.

After the completion of the measurements, the display controller 226 initially displays, on the display unit 26, the measurement data of the measurement target compounds extracted by the measurement filter. The screen thus displayed shows all measurement data obtained by the measurement controller 224 for the measurement target compounds extracted by the measurement filter. Therefore, this screen also corresponds to the second data-analysis screen in the present invention.

After the second data-analysis screen has been displayed by the display controller 226, the filter selection receiver 221 displays, on the display unit 26, a screen which allows the user to select a data-analysis filter. In this situation, the same filter as the measurement filter as well as the filters at the lower levels from this measurement filter are shown as the available options on this screen. For example, when the measurement filter corresponds to Attribute A, the data-analysis filters corresponding to Attribute A, Attribute A-1, Attribute A-1-1, Attribute A-2, Attribute A-3 and other related filters are displayed as the options. When the user has selected one of those data-analysis filters and confirmed the selection, the filter selection receiver 221 determines that the selected filter should be used as the data-analysis filter.

After the data-analysis filter has been determined, the analysis-target-compound extractor 223 extracts, from the compounds recorded in the compound database 211, one or more compounds as the data-analysis target compounds according to the content of the data-analysis filter. For example, when the data-analysis filter corresponds to Attribute A-1-1, Compounds 3, 7, 13, 18 and others are extracted as the data-analysis target compounds.

After the data-analysis target compounds have been extracted, the analysis data creator 225 reads the measurement data of the data-analysis target compounds (Compounds 3, 7, 13, 18 and others) from among the measurement data obtained by the measurements and analyzes those measurement data using the data-analysis information corresponding to those compounds.

After the analysis data for the data-analysis target compounds have been created, the display controller 226 displays, on the display unit 26, the measurement data and the analysis data of the data-analysis target compounds as the first data-analysis screen. This example also allows the user to appropriately add or remove data-analysis target compounds.

In the present example, since a subset of the compounds recorded in the compound database 211 is extracted as the measurement target compounds by means of a measurement filter, the number of compounds for which the measurement should be performed is smaller than in the case of performing the measurement for all compounds recorded in the compound database 211. Therefore, the measurement time can be shortened. Alternatively, it is also possible to increase the measurement sensitivity by extending the measurement time per one compound than in the case of performing the measurement for all compounds, or to improve the reproducibility of the measurement by shortening the measurement cycle. Furthermore, in the present example, since a subset of the measurement target compounds is extracted as the data-analysis target compounds by the data-analysis filter, and only the measurement data and the analysis data of those data-analysis target compounds are displayed on the first data-analysis screen, the user can easily check the measurement data and the data-analysis results of the data-analysis target compounds (Compounds 3, 7, 13, 18 and others). The user can also view the second data-analysis screen to examine the measurement data of compounds which were initially excluded from the target of the data analysis (Compounds 2, 5, 6, 10-12, 14 and others) and see whether or not any of these compounds is contained in the sample.

The procedure for newly creating a filter to be used in the compound database 211 is hereinafter described.

The user collects information from academic papers or similar types of literature containing descriptions related to any of the compounds recorded in the compound database 211. For each relevant compound reported in each piece of literature, the user determines what attribute the sample handled in the literature has, and relates that compound to that attribute of the sample. In this manner, for example, a piece of information which relates Compounds 1, 5-9, 13, 15 and others to the sample of “Attribute Z” can be obtained.

Subsequently, the user issues a command to create a filter. Then, the filter creator 228 displays, on the display unit 26, a screen for inputting the filter name (i.e., information for identifying a filter, such as an attribute of the sample) to be added. After the user has inputted the filter name, the filter creator 228 displays a list of the compounds recorded in the compound database 211, with a checkbox for each compound. FIG. 7 shows one example. Based on the information obtained from the literature, the user selects the checkboxes corresponding to the compounds contained in the sample having the attribute concerned among the displayed compounds and confirms the selection. Then, a filter in which the filter name (attribute of the sample) inputted by the user is related to the selected compounds is created.

It is also possible to create a filter based on the result of a measurement and a data-analysis performed by the user. For a sample having an attribute which should be newly registered, the user obtains measurement data by carrying out a measurement using the measurement information of the compounds recorded in the compound database 211. This measurement is also conducted by the measurement controller 224. The analysis data creator 225 creates analysis data using the data-analysis information of those compounds. In the case of creating a new filter at the highest hierarchical level, the measurement and data analysis of the sample are performed using neither the measurement filter nor the data-analysis filter. In the case of creating a new filter at a level under an existing filter, a filter at a level higher than the filter to be created may be used as the measurement filter as well as the data-analysis filter. The filter creator 228 identifies the compounds contained in the sample from the data-analysis result obtained by the analysis data creator 225. Thus, a piece of information which relates the attribute of the sample to the compounds contained in the sample having the attribute concerned is obtained. Subsequently, the filter creator 228 creates a new filter by selecting the compounds contained in the sample having the attribute concerned among the compounds recorded in the compound database 211 and relating them to the filter name inputted by the user.

The compounds detected from a sample by a measurement and data analysis of the sample may possibly contain irrelevant compounds, such as a compound that will also be detected from a blank sample. If this type of compound is extracted as a measurement target compound or data-analysis target compound, a false-positive result may be obtained in the measurement and data analysis of a real sample. Accordingly, it is preferable to exclude this type of compound from the data-analysis target compounds beforehand even though they are expected to be detected from samples. Accordingly, the filter creator 228 displays, on the display unit 26, a list of compounds which have been identified as compounds contained in the sample according to an input operation by the user and prompts the user to indicate compounds which should be removed from the list. After the compounds to be removed have been indicated by the user, the filter creator 228 removes the compounds indicated by the user from the list of the compounds which have been identified as compounds contained in the sample, and creates a new filter.

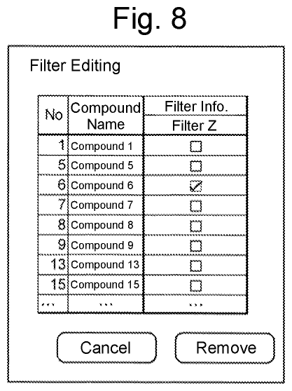

It is also possible to edit a filter already held in the compound database 211. The user issues a command to initiate the editing of a filter. Then, the filter creator 228 displays a list of filters and prompts the user to select a filter to be edited. When the user has selected a filter, a list of the compounds related to that filter is displayed. The user views this list, selects a compound or compounds that may possibly yield a false-positive result, and confirms the removal of those compounds. The filter creator 228 removes the selected compounds from the list, updates the filter information, and saves it in the compound database 211. FIG. 8 shows an example of the filter-editing screen.

The previous embodiment is a mere example and can be appropriately changed or modified along the gist of the present invention. Although the compound database 211 in the previous embodiment is a database related to metabolites, a database similar to the previously described one can also be used in the case of analyzing other types of known compounds.

The sample analyzing device in the previous embodiment is a gas chromatograph mass spectrometer 1. A different type of sample analyzing device may also be used for the measurement of the compounds contained in a sample. In that case, a compound database prepared for that sample analyzing device should be used.

The previous embodiment is one preferable mode of the present invention. It is not always necessary to provide all components described in the previous embodiment. For example, the present invention can be carried out by a device which does not include the measurement-target-compound extractor 222, analysis-target-compound changer 227 and filter creator 228.

The previous embodiment is concerned with the case where the measurement data of the data-analysis target compounds are analyzed, and the thereby obtained result is displayed on the first data-analysis screen. It is also possible to omit the analysis of measurement data and display only the measurement data of the data-analysis target compounds on the first data-analysis screen. In that case, for example, the device can be configured to perform analytical data processing, such as the calculation of the quantitative value, based on additional instructions from the user, and the analysis data creator 225 may be omitted.

In the previous embodiment, the user directly selects the desired filters. The filter selection receiver 221 may receive the selection of a filter in a different way. For example, it may be configured to automatically select a filter according to a predetermined criterion, e.g., by automatically selecting a filter corresponding to a sample name inputted by the user for an analysis of a sample.

In the previous embodiment, the use or non-use of a data-analysis filter is selected after the measurement of the sample has been performed after the selection of the use or non-use of a measurement filter. The use or non-use of the data-analysis filter may be selected before the measurement of the sample. Additionally, in the previous embodiment, the second data-analysis screen is displayed after the measurement of the sample, and the first data-analysis screen is subsequently displayed when the user has selected the use of the data-analysis filter. In the case of selecting a data-analysis filter before the measurement of the sample, the first data-analysis screen may be displayed after the measurement of the sample, and the second data-analysis screen may be displayed at a later point in time according to a command from the user.

[Modes]

A person skilled in the art can understand that the previously described illustrative embodiments are specific examples of the following modes of the present invention.

### Clause 1

A sample analyzing device according to one mode of the present invention includes:
a storage section which holds information concerning measurement conditions and information concerning data-analysis methods for each of a plurality of known compounds as well as information concerning a plurality of data filters each of which extracts a subset of the plurality of known compounds;
a display section;
a measurement controller configured to obtain measurement data of a sample containing one or a plurality of the plurality of known compounds by performing a measurement based on the information concerning one or a plurality of measurement conditions held in the storage section;
a filter selection receiver configured to receive an input for selecting one of the plurality of data filters as a data-analysis filter to be applied to an analysis of the measurement data of the sample;
an analysis-target-compound extractor configured to extract, as data-analysis target compounds, a subset of the plurality of known compounds by the data-analysis filter; and
a display controller configured to display, on the display section, a first data-analysis screen for displaying measurement data of the data-analysis target compounds extracted from the measurement data of the sample and a second data-analysis screen for displaying all measurement data.

The sample analyzing device according to Clause 1 includes a storage section which holds not only information concerning the measurement condition and data-analysis method for each of a plurality of known compounds, but also information concerning a plurality of data-filters for extracting a subset of the plurality of known compounds. For example, this type of data filter is created based on the result of a past analysis or that of a measurement and data analysis of a real sample. For example, a set of filters each of which has been prepared for each attribute of samples or for each purpose of the analysis of samples can be used as the plurality of data filters. Another possible example is a filter designed for a specific attribute of samples (e.g., “plant”) so as to extract, from the compound database, a plurality of compounds exclusive of those which are unlikely to be contained in a sample having that specific attribute (e.g., a metabolite which can only be produced in animals). In any of these cases, a filter suitable for the attribute of the sample or purpose of the analysis can be selected as a data filter for data analysis from a plurality of filters held in the storage section.

When an analysis of a sample containing one or a plurality of the plurality of known compounds is performed, a measurement using the information concerning the measurement conditions held in the storage section is performed to obtain measurement data of the sample. The filter selection receiver receives, for example, the selection of a data filter by the user. The filter selection receiver does not always need to be configured to receive the selection of a data filter by a user; it may also be configured to automatically select a data filter according to a predetermined criterion, e.g., by automatically selecting the data filter corresponding to a sample name inputted by the user for a data-analysis of a sample.

The created measurement data of the data-analysis target compounds are displayed, on the display section, as a first data-analysis screen by the display controller. Additionally, all measurement data obtained by the measurement controller are displayed as the second data-analysis screen by the display controller. The display of the first and second data-analysis screens by the display controller may be performed in such a manner that those screens are displayed in a switchable manner on the display section, or that they are simultaneously displayed next to each other. In the sample analyzing device according to Clause 1, for example, the user only needs to perform a simple operation for selecting a data filter for data analysis according to the content of the analysis of the sample to narrow down the compounds to be analyzed. In response to this operation, the first data-analysis screen which shows measurement data of those data-analysis target compounds is displayed, allowing the user to easily analyze those compounds. Measurement data of the compounds other than the data-analysis target compounds can also be checked on the second data-analysis screen.

### Clause 2

In the sample analyzing device according to Clause 1, the plurality of known compounds may be partially or entirely metabolites, and the plurality of data filters may be prepared according to an attribute of samples.

In the sample analyzing device according to Clause 2, a plurality of filters corresponding to different attributes of samples are used as the plurality of data filters to be held in the storage section. The sample analyzing device according to Clause 2 can be suitably used in metabolomics aimed at analyzing metabolites contained in samples of various attributes, such as plant or animal.

### Clause 3

The sample analyzing device according to Clause 1 or 2 may be configured as follows:
the filter selection receiver is further configured to receive an input for selecting one of the plurality of data filters as a measurement filter to be applied to the measurement of the sample;
the sample analyzing device further includes a measurement-target-compound extractor configured to extract a subset of the plurality of known compounds as measurement target compounds by using the measurement filter; and
the measurement controller obtains the measurement data of the sample by performing a measurement using the information concerning measurement conditions of the measurement target compounds held in the storage section.

### Clause 4

In the sample analyzing device according to one of Clauses 1-3, the plurality of data filters may include a first filter for extracting a subset of the plurality of known compounds held in the storage section and a second filter for extracting a subset of the known compounds extracted by the first filter.

### Clause 5

The sample analyzing device according to Clause 3 may be configured as follows:
the plurality of data filters include a first filter for extracting a subset of the plurality of known compounds held in the storage section and a second filter for extracting a subset of the known compounds extracted by the first filter; and
the filter selection receiver receives the selection of the first filter or the second filter as the data-analysis filter when the first filter is selected as the measurement filter, as well as receives the selection of the second filter as the data-analysis filter when the second filter is selected as the measurement filter.

In the sample analyzing devices according to Clauses 3 and 5, the data filters held in the storage section are used not only as a filter for data analysis but also as a filter for measurement. By using the first filter to narrow down the compounds to be subjected to the measurement, the sample analyzing devices according to Clauses 3 and 5 can improve the sensitivity or reproducibility of the measurement by extending the measurement time per one compound or shortening the measurement cycle.

In the sample analyzing devices according to Clauses 4 and 5, since the first and second filters are provided in a hierarchical form, a more suitable filter for the attribute of the sample or the purpose of the analysis can be used.

### Clause 6

The sample analyzing device according to one of Clauses 1-5 may further include an analysis-target-compound changer configured to receive an addition and removal of the data-analysis target compounds, and the display controller may display, on the first data-analysis screen, the measurement data of the data-analysis target compounds after a change received by the analysis-target-compound changer is applied.

In the sample analyzing device according to Clause 6, when a compound has been detected which has not been extracted by the data-analysis filter since its presence in the sample was not expected before the measurement, the compound can be added to the list of the data-analysis target compounds, and the measurement data of that compound can be easily checked on the first data-analysis screen.

### Clause 7

The sample analyzing device according to one of Clauses 1-6 may further include a filter creator configured to create a new filter according to an input of information identifying the filter as well as the selection of a subset of the plurality of known compounds held in the storage section, and to save the new filter in the storage section.

The sample analyzing device according to Clause 7 allows the user to create a desired filter and add it to a compound database.

### Clause 8

In the sample analyzing device according to Clause 7, the filter creator may select a subset of the plurality of known compounds held in the storage section, based on the result of an analysis performed for identifying compounds in a sample by analyzing, by the data-analysis methods, the measurement data of the sample obtained by the measurement controller.

### Clause 9

In the sample analyzing device according to Clause 8, the filter creator may select a subset of the plurality of known compounds held in the storage section, by receiving an input which specifies a subset of the identified compounds, and excluding the specified compounds from the identified compounds.

In the sample analyzing device according to Clause 8, a filter can be added to the compound database, based on the result of an analysis of the measurement data obtained by a measurement of a real sample. When conducting a measurement of a real sample, the measurement controller may perform the measurement on all of the plurality of compounds held in the storage section, or it may perform the measurement on only a subset of the plurality of compounds selected by using a measurement filter or similar means. Typically, the task of obtaining data-analysis results by the data-analysis methods held in the storage section is performed for all compounds for which the measurement was performed, although the task of obtaining data-analysis results by the data-analysis methods held in the storage section may also be performed only for a subset of the compounds for which the measurement was performed.

Typically, the filter created in the sample analyzing device according to Clause 8 is designed to extract all compounds which have been identified as being contained in the real sample based on the data-analysis results. However, as in the sample analyzing device according to Clause 9, the filter may also be created after excluding a subset of the identified compounds. The sample analyzing device according to Clause 9 allows the user to indicate specific compounds among those which have been detected in the measurement and data analysis of a real sample, such as the compounds which will also be detected from a blank sample. This enables the creation of a filter which removes those specific compounds and extracts the other compounds from among the identified compounds. This filter decreases the possibility that a false-positive result is yielded in the measurement and data analysis of a sample.

### Clause 10

Another mode of the present invention is a method for creating a filter for extracting, from a database which holds information concerning measurement conditions and data-analysis methods for a plurality of known compounds, a subset of the plurality of known compounds as measurement target compounds in a measurement of a sample or as data-analysis target compounds in an analysis of measurement data of a sample, the method including the steps of:
collecting information concerning a piece of literature which contains a description concerning any one of the plurality of known compounds;
relating a known compound mentioned in the literature to an attribute of a sample, based on the information in the literature; and
creating a filter for extracting known compounds related to the attribute of the sample in response to a selection of the attribute.

By the method according to Clause 10, a new filter can be created based on the results of measurements or data analyses published in academic papers or similar types of literature.

### REFERENCE SIGNS LIST

1 . . . Gas Chromatograph Mass Spectrometer
10 . . . Measurement Unit (Gas Chromatography-Mass Spectrometry Unit)
20 . . . Control-and-Processing Unit
21 . . . Storage Section
211 . . . Compound Database
221 . . . Filter Selection Receiver
222 . . . Measurement-Target-Compound Extractor
223 . . . Analysis-Target-Compound Extractor
224 . . . Measurement Controller
225 . . . Analysis Data Creator
226 . . . Display Controller
227 . . . Analysis-Target-Compound Changer
228 . . . Filter Creator
25 . . . Input Unit
26 . . . Display Unit

1. A sample analyzing device, comprising:
a storage section which holds information concerning measurement conditions and information concerning data-analysis methods for each of a plurality of known compounds as well as information concerning a plurality of data filters each of which extracts a subset of the plurality of known compounds;
a display section;
a measurement controller configured to obtain measurement data of a sample containing one or a plurality of the plurality of known compounds by performing a measurement based on information concerning one or a plurality of the measurement conditions held in the storage section;
a filter selection receiver configured to receive an input for selecting one of the plurality of data filters as a data-analysis filter to be applied to an analysis of the measurement data of the sample;
an analysis-target-compound extractor configured to extract, as data-analysis target compounds, a subset of the plurality of known compounds by the data-analysis filter; and
a display controller configured to display, on the display section, a first data-analysis screen for displaying measurement data of the data-analysis target compounds extracted from the measurement data of the sample and a second data-analysis screen for displaying all measurement data.

2. The sample analyzing device according to claim 1, wherein the plurality of known compounds are partially or entirely metabolites, and the plurality of data filters are prepared according to an attribute of samples.

3. The sample analyzing device according to claim 1, wherein:
the filter selection receiver is further configured to receive an input for selecting one of the plurality of data filters as a measurement filter to be applied to the measurement of the sample;
the sample analyzing device further includes a measurement-target-compound extractor configured to extract a subset of the plurality of known compounds as measurement target compounds by using the measurement filter; and
the measurement controller obtains the measurement data of the sample by performing a measurement using the information concerning measurement conditions of the measurement target compounds held in the storage section.

4. The sample analyzing device according to claim 1, wherein the plurality of data filters includes a first filter for extracting a subset of the plurality of known compounds held in the storage section and a second filter for extracting a subset of the known compounds extracted by the first filter.

5. The sample analyzing device according to claim 3, wherein:
the plurality of data filters include a first filter for extracting a subset of the plurality of known compounds held in the storage section and a second filter for extracting a subset of the known compounds extracted by the first filter; and
the filter selection receiver receives a selection of the first filter or the second filter as the data-analysis filter when the first filter is selected as the measurement filter, as well as receives a selection of the second filter as the data-analysis filter when the second filter is selected as the measurement filter.

6. The sample analyzing device according to claim 1, further comprising an analysis-target-compound changer configured to receive an addition and removal of the data-analysis target compounds, wherein:
the display controller may display, on the first data-analysis screen, the measurement data of the data-analysis target compounds after a change received by the analysis-target-compound changer is applied.

7. The sample analyzing device according to claim 1, further comprising a filter creator configured to create a new filter according to an input of information identifying the filter as well as a selection of a subset of the plurality of known compounds held in the storage section, and to save the new filter in the storage section.

8. The sample analyzing device according to claim 7, wherein the filter creator selects a subset of the plurality of known compounds held in the storage section, based on a result of an analysis performed for identifying compounds in a sample by analyzing, by the data-analysis methods, the measurement data of the sample obtained by the measurement controller.

9. The sample analyzing device according to claim 8, wherein the filter creator selects a subset of the plurality of known compounds held in the storage section, by receiving an input which specifies a subset of the identified compounds, and excluding the specified compounds from the identified compounds.

10. A method for creating a filter for extracting, from a database which holds information concerning measurement conditions and data-analysis methods for a plurality of known compounds, a subset of the plurality of known compounds as measurement target compounds in a measurement of a sample or as data-analysis target compounds in an analysis of measurement data of a sample, the method comprising steps of:
collecting information concerning a piece of literature which contains a description concerning any one of the plurality of known compounds;
relating a known compound mentioned in the literature to an attribute of a sample, based on the information in the literature; and
creating a filter for extracting known compounds related to the attribute of the sample in response to a selection of the attribute.
